(19) United States
(12) Patent Application Publication
(10) Pub. No.: US 2007/0098400 A1
(43) Pub. Date: May 3, 2007

(54) Lens module and digital camera module using the same

(75) Inventor: Ga-Lane Chen, Fulleton, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/448,569

(22) Filed: Jun. 7, 2006

(30) Foreign Application Priority Data
Oct. 28, 2005 (CN) 200510100798.8
Oct. 28, 2005 (CN) 200510100803.5

(51) Int. Cl. G03B 17/00

(52) U.S. Cl. 396/529

(57) ABSTRACT

An exemplary lens module includes a lens barrel, a lens unit and an aperture stop. The lens barrel includes a receiving part defining a passage therein. The lens unit is made of glass. The aperture stop is made from an iron-nickel based alloy having a thermal expansion coefficient matching with that of glass. The lens unit and the aperture stop are received in the passage of the receiving part in succession order from an object side to an image side of the lens module. Digital camera modules using such kind of lens modules are also provided.

### BACKGROUND

1. Technical Field

This invention relates generally to optical imaging apparatuses, and more particularly to lens modules and digital camera modules using the same.

2. Related Art

Nowadays, digital camera modules are widely accepted for their ease of use, digital image storage, immediate results and image management potential, for example, employed in mobile phones. Commonly, the digital camera modules work at various outdoor environments having different temperatures and humidities, so the reliability of working in the various environments to lens modules of the digital camera modules is one of critical factors to achieve a high imaging quality.

A typical lens module of a digital camera module includes a lens barrel, and a first glass lens, an aperture stop, a second glass lens, a spacer and an IR cut filter received in the lens barrel in that order from an object side to an image side of the lens module. Usually, the aperture stop and the spacer are made of either polymer materials (e.g., carisoprodol) or dark-painted copper or brass. However, the polymer materials and dark-painted copper or brass are prone to generate thermal-induced deformations due to their different thermal expansion coefficients comparing with glass. The thermal-induced deformations of the aperture stop and/or spacer may cause tilt, bending, and deformation on their neighboring lenses, which will result in a deteriorated imaging quality of the digital camera modules.

What is needed is to provide a lens module and a digital camera module using the same having a better environment-tolerance.

### SUMMARY

A preferred embodiment provides a lens module including: a lens barrel, a lens unit and an aperture stop. The lens barrel includes a receiving part defining a passage therein. The lens unit is made of glass. The aperture stop is made from an iron-nickel based alloy having a thermal expansion coefficient matching with that of glass. The lens unit and the aperture stop are received in the passage of the receiving part in succession order from an object side to an image side of the lens module.

In another preferred embodiment, a digital camera module includes a lens module as above described, an image sensor and a holder. The holder defines an opening therein. The receiving part of the lens barrel of the lens module as above described is engaged in the opening. The image sensor is received in the opening and arranged at the image side.

Other advantages and novel features will become more apparent from the following detailed description of embodiments when taken in conjunction with the accompanying drawings.

### BRIEF DESCRIPTION OF THE DRAWINGS

Many aspects of the present lens module and digital camera module using the same can be better understood with reference to the following drawings. The components in the drawings are not necessarily to scale, the emphasis instead being placed upon clearly illustrating the principles of the present lens module and digital camera module. Moreover, in the drawings, like reference numerals designate corresponding parts throughout the several views.

FIG. 1 is a schematic, cross-sectional view of a lens module in accordance with a preferred embodiment; and

FIG. 2 is a schematic, cross-sectional view of a digital camera module using the lens module of FIG. 1.

The exemplifications set out herein illustrate preferred embodiments, in various forms, and such exemplifications are not to be construed as limiting the scope of the present lens module and digital camera module in any manner.

### DETAILED DESCRIPTION OF PREFERRED EMBODIMENTS

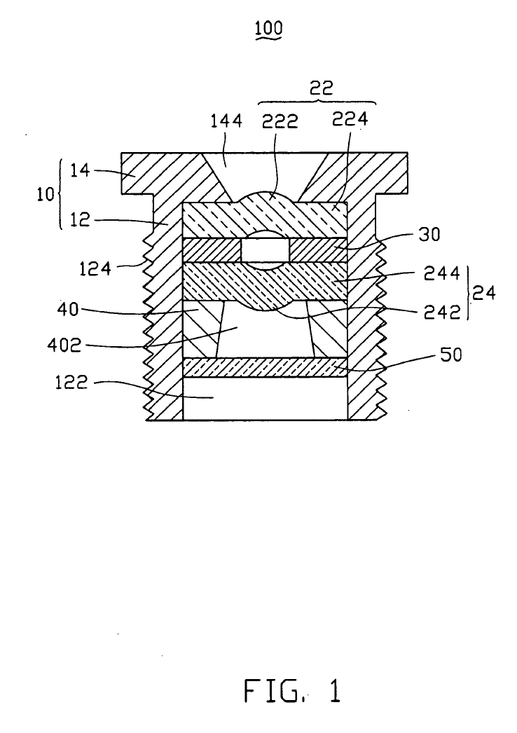

Referring to FIG. 1, a lens module 100 in accordance with a preferred embodiment of present invention is shown. The lens module 100 includes a lens barrel 10, lens units 22, 24, an aperture stop 30, a spacer 40 and a filter 50. The lens unit 22, aperture stop 30, lens unit 24, spacer 40 and filter 50 are received and fixed in the lens barrel 10 in succession order from an object side to an image side of the lens module 100.

The lens barrel 10 includes a receiving part 12 and a front part 14. The receiving part 12 has a cylindrical shape and defines a passage 122 therein. The receiving part 12 usually has an external thread 124 on an outward circumference thereof. The passage 122 is configured for receiving the lens units 22, 24, aperture stop 30, spacer 40 and filter 50 therein. The front part 14 has a cone-shaped passage 144 defined in a central portion thereof. A diameter of the cone-shaped passage 144 gradually decreases along a direction from the object side to the image side. The cone-shaped passage 144 is connected with the passage 122 of the receiving part 12. Incident light beams passing through the cone-shaped passage 144 can reach into the passage 122 and incident on the lens units 22, 24 and the filter 50.

The lens units 22, 24 are usually made of glass and can be aspherical lenses or spherical lenses. The lens unit 22 includes a transparent central region 222 and a peripheral region 224 surrounding the transparent central region 222. Likewise, the lens unit 24 includes a transparent central region 242 and a peripheral region 244 surrounding the transparent central region 242.

The aperture stop 30 usually is dark-painted annular sheet which has a thickness in the range from 30 to 70 micrometers and an inner diameter in the range from 0.3 to 0.8 micrometers. Preferably, the annular sheet has a thickness in the range from 40 to 60 micrometers and an inner diameter in the range from 0.4 to 0.6 micrometers.

The spacer 40 is configured for separating optical elements such as lens unit 24 and filter 50, and for thereby forming a space therebetween. The spacer 40 generally has a configuration matching with the passage 122 and defines a passage 402 therein. The passage 402 usually has a cone shape having a diameter increasing along the direction for the object side to the image side.

The aperture stop 30 and the spacer 40 are made from a material having a thermal expansion coefficient matching with (i.e., similar as) that of glass from which the lens units 22, 24 are made. This characteristic of the material can beneficially prevent the neighboring glass lens units 22, 24 of the aperture stop 30 and/or the spacer 40 from tilt, bending, and deformation when the lens module 100 working at various different environments. For example, the aperture stop 30 and the spacer 40 are made from an iron-nickel based (FeNi-based) alloy. The FeNi-based alloy may have a tensile strength of 67,000 pounds per square inch (psi) and can be used in a wide temperature range from −40° C. to 85° C. and tolerate a relative humidity in the range from 5% to 90%. In particular, in one embodiment, the FeNi-based alloy is an invar alloy. The invar alloy can be composed of 62.51% iron (Fe), 36% nickel (Ni), 0.25% chromium (Cr), 0.5% manganese (Mn), 0.25% silicon (Si), 0.05% carbon (C), 0.1% aluminum (Al), 0.1% magnesium (Mg), 0.1% zirconium (Zr), 0.1% titanium (Ti), 0.02% phosphorus (P) and 0.02% sulfur (S) by weight; or 58.07˜60.17% iron, 39˜41.1% nickel, 0.05% chromium, 0.6% manganese, 0.02% silicon, 0.05% carbon, 0.02% aluminum, 0.05% cobalt (Co), 0.02% phosphorus and 0.02% sulfur by weight. In another embodiment, the FeNi-based alloy is a kovar alloy (i.e., iron-nickel-cobalt based alloy). The kovar alloy can be composed of 52˜53% iron, 29% nickel, 17% cobalt, and 1˜2% residual composition by weight, the residual composition is selected from the group consisting of magnesium, manganese, silicon, carbon, aluminum, zirconium, titanium, phosphorus, sulfur, and an mixture thereof. For example, the kovar alloy is composed of 52.79% iron, 29% nickel, 17% cobalt, 0.1% magnesium, 0.5% manganese, 0.2% silicon, 0.06% carbon, 0.1% aluminum, 0.1% zirconium, 0.1% titanium, 0.025% phosphorus, and 0.025% sulfur by weight.

The filter 50 usually is an infrared (IR) cut filter which includes a glass base and an IR cut coating formed on at least one surface of the glass base member. This IR cut filter can be used to filter infrared rays.

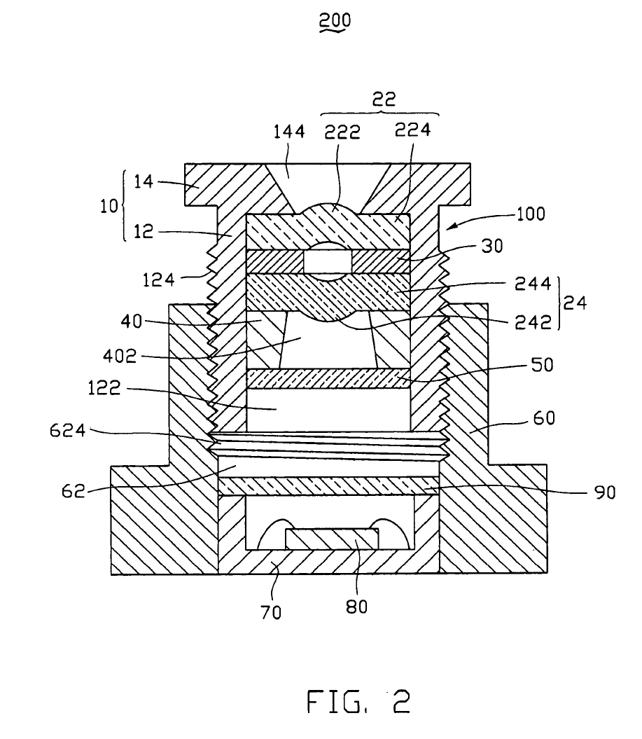

Referring to FIG. 2, a digital camera module 200 incorporating the above-described lens module 100 is shown. The digital camera module 200 includes the lens module 100 as above described, a holder 60, a base member 70, an image sensor 80 and a cover 90.

The holder 60 defines an opening 62 therein. An internal thread 624 is defined on peripheral sidewalls of the opening 62. The internal thread 624 is engaged together with the external thread 124 of the lens barrel 10 for thereby holding the lens module 100.

The base member 70 is received in the opening 62 of the holder 60. The base member 70 usually defines a cavity in a surface thereof adjacent to the lens module 100 for receiving the image sensor 80. In the illustrated embodiment, the base member 70 is made from ceramic.

The image sensor 80 is fixed in the base member 70 and configured for detecting optical signals representative of a target image and converting the optical signals into corresponding electronic signals. The image sensor 80 usually is a charge coupled device (CCD) or a complementary metal-oxide semiconductor (CMOS) device.

The cover 90 is arranged on the base member 70 for covering the opening of the base member 70. The cover 90 usually is used to protect the image sensor 80 fixed in the base member 70 from contaminations, such as dust and/or water vapor. The cover 90 is usually made of a transparent material, such as transparent glass.

In summary, the aperture stop and the spacer in the above described preferred embodiments are made from a material (e.g., FeNi-based alloy) having a thermal expansion coefficient matching with that of glass from which the lens units are made. When such kinds of aperture stop and/or spacer are employed in optical imaging apparatuses such as, lens modules and digital camera modules, they can render the optical imaging apparatuses achieving a better environment-tolerance and then a high imaging quality.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A lens module comprising:
a lens barrel including a receiving part defining a passage therein;
a first lens unit made of glass; and
an aperture stop made from an iron-nickel based alloy having a thermal expansion coefficient matching with that of glass, the first lens unit and the aperture stop are received in the passage of the receiving part in succession order from an object side to an image side of the lens module.

2. The lens module of claim 1, wherein the iron-nickel based alloy is selected from the group consisting of an invar alloy and a kovar alloy.

3. The lens module of claim 2, wherein the invar alloy is selected from the group consisting of a first composition composed of 62.51% iron, 36% nickel, 0.25% chromium, 0.5% manganese, 0.25% silicon, 0.05% carbon, 0.1% aluminum, 0.1% magnesium, 0.1% zirconium, 0.1% titanium, 0.02% phosphorus and 0.02% sulfur by weight, and a second composition composed of 58.07˜60.17% iron, 39˜41.1% nickel, 0.05% chromium, 0.6% manganese, 0.02% silicon, 0.05% carbon, 0.02% aluminum, 0.05% cobalt, 0.02% phosphorus and 0.02% sulfur by weight.

4. The lens module of claim 2, wherein the kovar alloy is composed of 52˜53% iron, 29% nickel, 17% cobalt and 1˜2% residual composition by weight, the residual composition is selected from the group consisting of magnesium, manganese, silicon, carbon, aluminum, zirconium, titanium, phosphorus, sulfur and an mixture thereof.

5. The lens module of claim 1, further comprising a second lens unit made of glass, wherein the second lens unit is received in the passage and cooperates with the first lens to sandwich the aperture stop therebetween.

6. The lens module of claim 5, further comprising a filter and a spacer made from the iron-nickel based alloy, wherein the filter is received in the passage and arranged closest to the image side, the spacer is received in the passage and arranged between the second lens unit and the filter.

7. The lens module of claim 6, wherein the iron-nickel based alloy is selected from the group consisting of an invar alloy and a kovar alloy.

8. The lens module of claim 7, wherein the invar alloy is selected from the group consisting of a first composition composed of 62.51% iron, 36% nickel, 0.25% chromium, 0.5% manganese, 0.25% silicon, 0.05% carbon, 0.1% aluminum, 0.1% magnesium, 0.1% zirconium, 0.1% titanium, 0.02% phosphorus and 0.02% sulfur by weight, and a second composition composed of 58.07˜60.17% iron, 39˜41.1% nickel, 0.05% chromium, 0.6% manganese, 0.02% silicon, 0.05% carbon, 0.02% aluminum, 0.05% cobalt, 0.02% phosphorus and 0.02% sulfur by weight.

9. The lens module of claim 7, wherein the kovar alloy is composed of 52˜53% iron, 29% nickel, 17% cobalt and 1˜2% residual composition by weight, the residual composition is selected from the group consisting of magnesium, manganese, silicon, carbon, aluminum, zirconium, titanium, phosphorus, sulfur and an mixture thereof.

10. The lens module of claim 1, wherein the lens barrel further comprises a front part arranged closest to the object side, the front part defines another cone-shaped passage therein with a diameter decreasing along a direction from the object side to the image side, and the another cone-shaped passage is in communication with the passage of the receiving part.

11. A digital camera module comprising:
a lens module, wherein the lens module comprises a lens barrel including a receiving part defining a passage therein, a first lens unit made of glass and an aperture stop made from an iron-nickel based alloy having a thermal expansion coefficient matching with that of glass, the first lens and the aperture stop being received in the passage of the receiving part in succession order from an object side to an image side;
an image sensor; and
a holder defining an opening therein, the receiving part of the lens barrel being engaged in the opening, the image sensor being received in the opening and arranged at the image side.

12. The digital camera module of claim 11, wherein the iron-nickel based alloy is selected from the group consisting of an invar alloy and a kovar alloy.

13. The digital camera module of claim 11, the lens module further comprises a second lens unit made of glass, wherein the second lens unit is received in the passage and cooperates with the first lens unit to sandwich the aperture stop therebetween.

14. The digital camera module of claim 13, the lens module further comprises a filter and a spacer made from the iron-nickel based alloy, wherein the filter and the spacer are received in the passage and located between the second lens unit and the image sensor, the filter is adjacent to the image sensor.

15. The digital camera module of claim 14, wherein the iron-nickel based alloy is selected from the group consisting of an invar alloy and a kovar alloy.

16. The digital camera module of claim 11, wherein the lens barrel further comprises a front part arranged closest to the object side, the front part defines an additional cone-shaped passage therein with a diameter decreasing along a direction from the object side to the image side, and the additional cone-shaped passage is in communication with the passage of the receiving part.

17. The digital camera module of claim 11, further comprising a base member receiving in the opening, the base member defines a cavity in a surface thereof facing toward the aperture stop, and the image sensor is received in the cavity.

18. The digital camera module of claim 17, further comprising a cover, wherein the cover is received in the opening and arranged on the base member configured for covering the image sensor.

19. A lens module comprising:
a lens barrel defining a passage therein;
a lens unit made of glass;
a spacer made from an iron-nickel based alloy having a thermal expansion coefficient matching with that of glass; and
a filter including a base made of glass, the lens unit, the spacer and the filter are received in the passage in succession order from an object side to an image side of the lens module.

20. The lens module of claim 19, wherein the iron-nickel based alloy is selected from the group consisting of an invar alloy and a kovar alloy.
